(19) United States
(12) Patent Application Publication
(10) Pub. No.: US 2007/0162689 A1
(43) Pub. Date: Jul. 12, 2007

(54) Memory controller, memory module and memory system having the same, and method of controlling the memory system

(75) Inventor: Joo-Sun Choi, Yongin-si (KR)

Correspondence Address: MILLS & ONELLO LLP, ELEVEN BEACON STREET, SUITE 605, BOSTON, MA, 02108, US

(73) Assignee: Samsung Electronics Co., Ltd.

(21) Appl. No.: 11/649,477

(22) Filed: Jan. 4, 2007

(30) Foreign Application Priority Data
Jan. 10, 2006 (KR) 10-2006-0002500

(51) Int. Cl. G06F 13/28

(52) U.S. Cl. 711/105; 711/154

(57) ABSTRACT

A memory system includes a memory controller and a plurality of first memory components. The memory controller has a plurality of I/O channels, each of the I/O channels including a command/address bus and a data bus. The plurality of the first memory components are respectively coupled to the memory controller through the plurality of I/O channels. The memory controller respectively transmits commands/addresses and data to the plurality of first memory components through the plurality of I/O channels in order to independently control the plurality of first memory components.

### CROSS-REFERENCE TO RELATED APPLICATIONS

This application claims priority under 35 USC § 119 to Korean Patent Application No. 10-2006-0002500, filed on Jan. 10, 2006, in the Korean Intellectual Property Office (KIPO), the contents of which are incorporated herein in their entirety by reference.

### BACKGROUND OF THE INVENTION

1. Field of the Invention

The present invention relates to a memory system, and more particularly to a memory controller, a memory module and a memory system having the memory controller, and method of controlling the memory system.

2. Description of the Related Art

As the speed of operation of a central processing unit (CPU) in a computer system has increased, high-speed access and high-capacity data storage in a dynamic random access memory (DRAM) has been required.

FIG. 1 is a block diagram illustrating a conventional memory system employing a multi-drop mode.

Referring to FIG. 1, DRAM components DRAM11 through DRAMmn are arranged in a matrix configuration so as to satisfy high capacity requirements.

Rows in the DRAM components (i.e., DRAM11 through DRAM1n, DRAM21 through DRAM2n, . . . , and DRAMm1 through DRAMmn) respectively share command/address buses (i.e., CABUS1, CABUS2, . . . , and CABUSm). Columns in the DRAM components (i.e., DRAM11 through DRAMm1, DRAM12 through DRAMm2, . . . , and DRAM1n through DRAMmn) respectively share data buses (i.e., DBUS1, DBUS2, . . . , and DBUSn).

When the number of the DRAM components is increased in a column direction, load capacitance of a data I/O pin in a memory controller 12 is increased. In addition, when the number of the DRAM components is increased in a row direction, load capacitance of a command/address output pin in the memory controller 12 is increased.

When an operational frequency of the DRAM components is low, a signal may be successfully transmitted through the bus architecture employing a multi-drop mode as shown in FIG. 1, although the load capacitance of the data I/O pin or the command/address output pin is high. However, as the operational frequency of the DRAM components has been increased, signal attenuation has been increased by the load capacitance so that the signal may not be transmitted successfully.

Accordingly, the operational frequency may be limited due to the load capacitance, and the number of the DRAM components commonly connected to the data I/O pin or the command/address output pin may be also limited. When the operational speed is relatively fast, for example, in the DRAM device such as a double data rate (DDR) 2-DRAM device and a DDR 3-DRAM device, it may be not adequate to couple many DRAM components to a single pin.

Recently, a new bus architecture referred to as a point-to-point (P2P) mode has been actively studied so as to solve a problem related with the bus architecture employing the multi-drop mode. In a P2P mode, the number of the DRAM components directly coupled to a memory controller is limited due to a pin arrangement.

FIG. 2 is a block diagram illustrating a conventional memory system employing a point-to-point mode (P2P).

Hierarchical link architecture illustrated in FIG. 2 is employed in the P2P mode so as to increase the number of the DRAM components directly or indirectly coupled to a memory controller. Referring to FIG. 2, the memory system includes a memory controller 22, a primary DRAM component 24, and a secondary DRAM component 26. The primary DRAM component 24 is directly coupled to the memory controller 22 and transfers a command/address or data to the secondary DRAM component 26. The primary DRAM component 24 is coupled to the secondary DRAM component 26 by the P2P mode.

In the conventional memory system of FIG. 1, a plurality of the DRAM components arranged in the same rank shares a common command/address bus and may be operated in response to the common command. For example, although one of the DRAM components needs to receive a command, all the DRAM components arranged in the same rank may receive the command, thereby consuming unnecessary power. As a result, it becomes difficult to design an optimized memory space according to an application field, and freely adjust the number of the DRAM components, the number of I/O pins, a depth of a memory, the number of banks and a length of bursts.

Here, a memory capacity and the number of the DRAM components follow a two-square law. However, as application fields of the memory have been expanded to an area such as mobile devices, domestic appliances etc., a computing environment in lieu of a two-square law has been required.

When a system designer implements the memory system that follows the two-square law, unnecessary memory space therein is increased along with manufacturing cost.

### SUMMARY OF THE INVENTION

Accordingly, the present invention is provided to substantially obviate one or more problems due to limitations and disadvantages of the related art.

Some embodiments of the present invention provide a memory system capable of independently controlling memory components.

Some embodiments of the present invention provide a memory module capable of independently controlling memory components.

Some embodiments of the present invention provide a memory controller capable of independently controlling memory components.

Some embodiments of the present invention provide a method of controlling the memory system capable of independently controlling memory components.

According to one aspect, the present invention is directed to a memory system which includes a memory controller having a plurality of input/output (I/O) channels, each of which includes a command/address bus and a data bus, and a plurality of first memory components respectively coupled to the memory controller through the I/O channels. The memory controller transmits commands/addresses and data to the first memory components through the plurality of I/O channels in order to independently control the plurality of first memory components.

The memory system may further include a plurality of second memory components dependently coupled to at least one of the plurality of first memory components. The at least one of the first memory components respectively relay the commands/addresses and the data between the memory controller and the plurality of second memory components.

The plurality of first and second memory components may be mounted on a module board having an area for memory components of a number not greater than 2^{N+1}. The number of the first memory components arranged in a primary rank is 2^{N} and the number of the second memory components arranged in a secondary rank is 2^{N+1}.

The plurality of first and second memory components may be mounted on a module board having an area for memory components of a number of about 2^{N}. The number of the first memory components arranged in a primary rank is 2^{N}, the number of the second memory components arranged in a secondary rank is not greater than 2^{N}, and the first memory components are disposed on or over the second memory components.

At least one of a memory size, a number of banks, a depth of the bank, a page size and a burst length of the first memory components may be different from that of the second memory components.

According to another aspect, the present invention is directed to a method of controlling a memory system in which first and second memory components are respectively coupled to a memory controller through first and second channels includes writing first and second memory scheduling information respectively corresponding to the first and second memory components, controlling the first memory components according to the first memory scheduling information, and controlling the second memory components according to the second memory scheduling information.

Controlling the first memory components and controlling the second memory components may respectively include transmitting a command/address and data through the first and second channels.

Controlling the first memory components and controlling the second memory components may include rearranging the command/address and the data such that a total power consumed by the first memory components and the second memory components is reduced.

According to another aspect, the present invention is directed to a memory controller which includes a micro-code memory configured to store a program code for controlling the memory controller. Controlling the memory controller includes writing first and second memory scheduling information corresponding to first and second memory components, controlling the first memory components according to the first memory scheduling information, and controlling the second memory components according to the second memory scheduling information.

Controlling the first memory components and controlling the second memory components may include rearranging a command/address and data such that a total power consumed by the first memory components and the second memory components is reduced.

According to another aspect, the present invention is directed to a memory module which includes a module board having a plurality of I/O channels for coupling the module board to a memory controller, and a plurality of first memory components respectively coupled to the memory controller through the plurality of I/O channels. The first memory components are mounted on the module board. In this case, the first memory components respectively receive commands/addresses and data through the I/O channels from the memory controller and are independently operated.

The memory module may further include a plurality of second memory components dependently coupled to at least one of the first memory components. The at least one of the first memory components respectively relay the commands/addresses and the data between the memory controller and the plurality of second memory components.

Therefore, in accordance with the invention, a plurality of memory components may be controlled independently.

### BRIEF DESCRIPTION OF THE DRAWINGS

The foregoing and other objects, features and advantages of the invention will be apparent from the more particular description of preferred aspects of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram illustrating a conventional memory system employing a multi-drop mode.

FIG. 2 is a block diagram illustrating a conventional memory system employing a point-to-point mode.

FIG. 3 is a block diagram illustrating a memory system according to example embodiments of the present invention.

FIG. 4 is a flow chart illustrating a process of operating the memory controller in FIG. 3.

FIG. 5A through FIG. 5C are block diagrams illustrating various configurations of a memory module according to example embodiments of the present invention.

FIGS. 6A and 6B are block diagrams illustrating memory modules having hierarchical relay link architecture according to example embodiments of the present invention.

FIG. 7 is a timing diagram illustrating a read operation of the memory module in FIG. 6A.

FIGS. 8 through 11 are tables illustrating a configuration of a command/address packet.

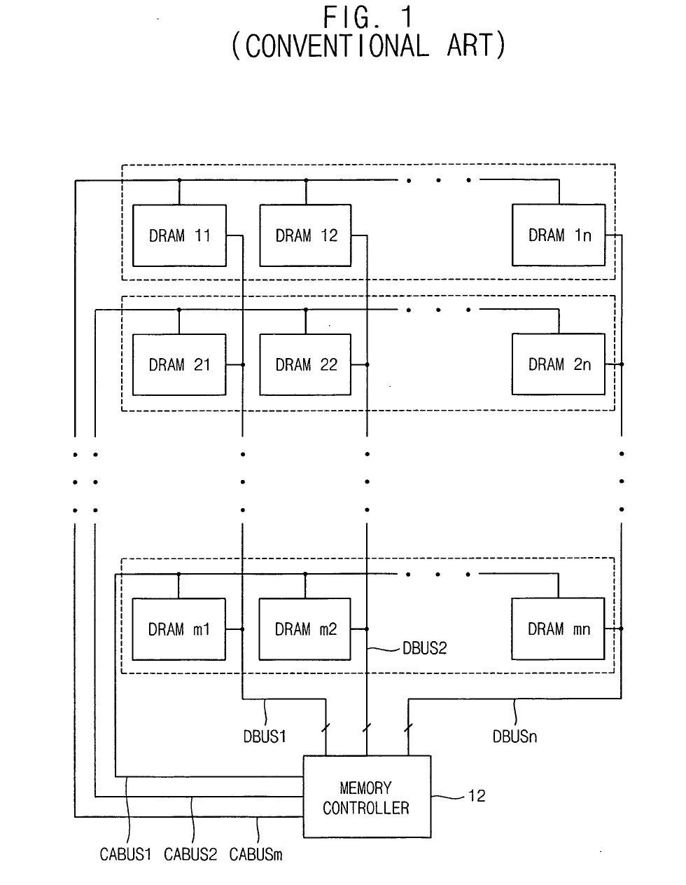

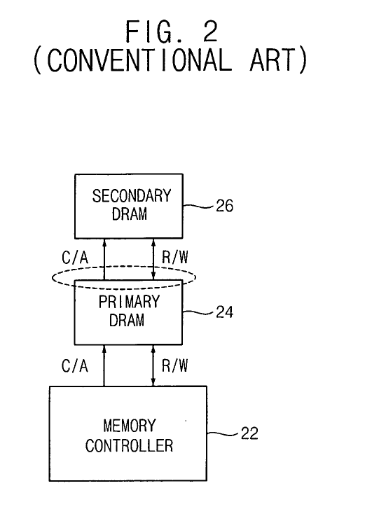

### DESCRIPTION OF THE EMBODIMENTS

Embodiments of the present invention now will be described more fully with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

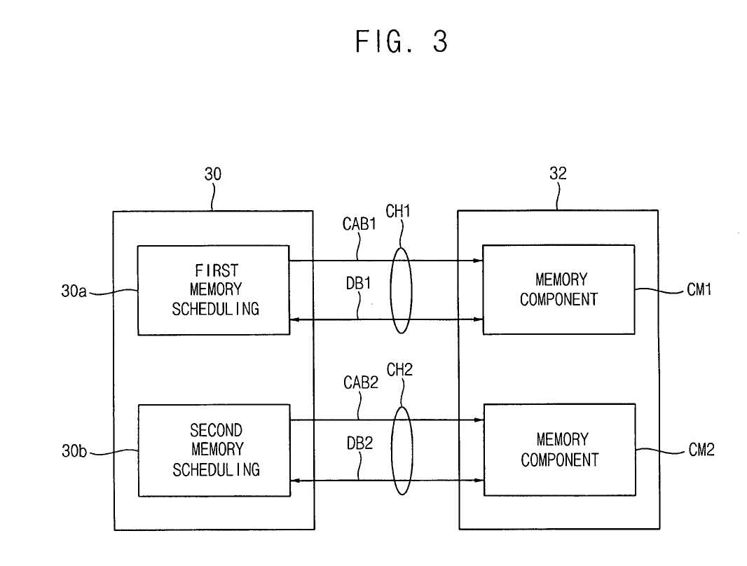

FIG. 3 is a block diagram illustrating a memory system according to example embodiments of the present invention.

Referring to FIG. 3, the memory system includes a memory controller 30 and a plurality of memory components 32.

The memory controller 30 includes a first memory scheduling block 30a and a second memory scheduling block 30b.

The first memory component CM1 is directly coupled to the memory controller 30 through a first I/O channel CH1, and the second memory component CM2 is directly coupled to the memory controller 30 through a second I/O channel CH2.

The first and second I/O channels CH1 and CH2 respectively include command/address buses CAB1 and CAB2, and data buses DB1 and DB2. The command/address buses CAB1 and CAB2 are unilateral, and the data buses DB1 and DB2 are bilateral. Each bus may be configured with one of a parallel bus architecture employed in a conventional memory and a serial bus architecture for transmitting a packet.

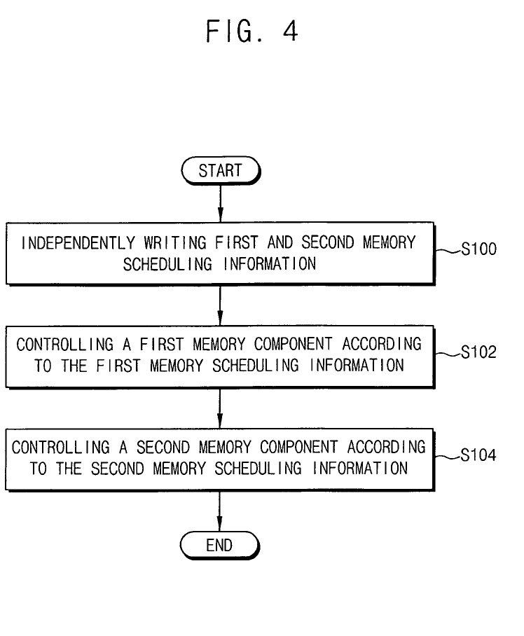

FIG. 4 is a flow chart illustrating a process of operating the memory controller in FIG. 3.

Referring to FIGS. 3 and 4, the memory controller 30 independently writes first memory scheduling information and second memory scheduling information in response to traffic information of the respective memory components CM1 and CM2 (Step S100). The first memory scheduling block 30a writes the first memory scheduling information related with the first memory component CM1, and the second memory scheduling block 30b writes the second memory scheduling information related with the second memory component CM2.

The memory controller 30 controls the first memory component CM1 based on the first memory scheduling information (Step S102), and controls the second memory component CM2 based on the second memory scheduling information (Step S104).

When the memory controller 30 writes the first and second memory scheduling information, the memory controller 30 estimates total power consumption while instantaneously operating the first and second memory components CM1 and CM2, and evenly distributes instant power consumption, thereby designing an optimum scheduling. For example when the first memory component CM1 performs an operation consuming large power such as a read operation or a write operation, the memory controller 30 writes the second memory scheduling information such that the second memory component CM2 is in a deep power down mode or performs an operation consuming small power such as a refresh operation and a precharge operation.

Therefore, the memory controller 30 may independently control the first and second memory components CM1 and CM2 though the command/address buses CAB1 and CAB2 and the data buses DB1 and DB2.

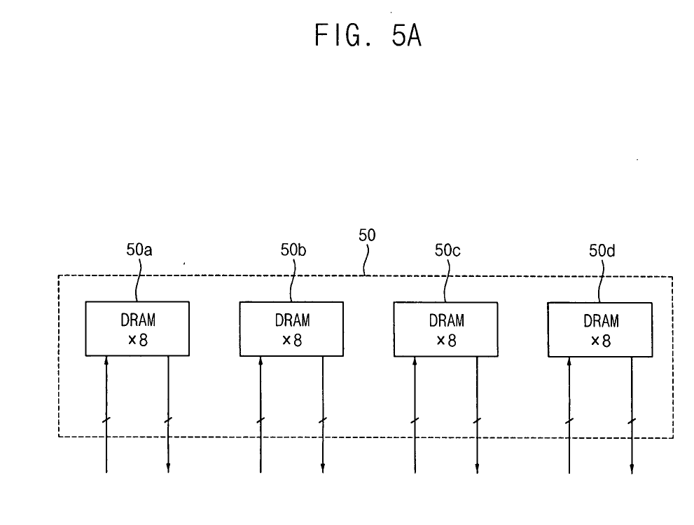

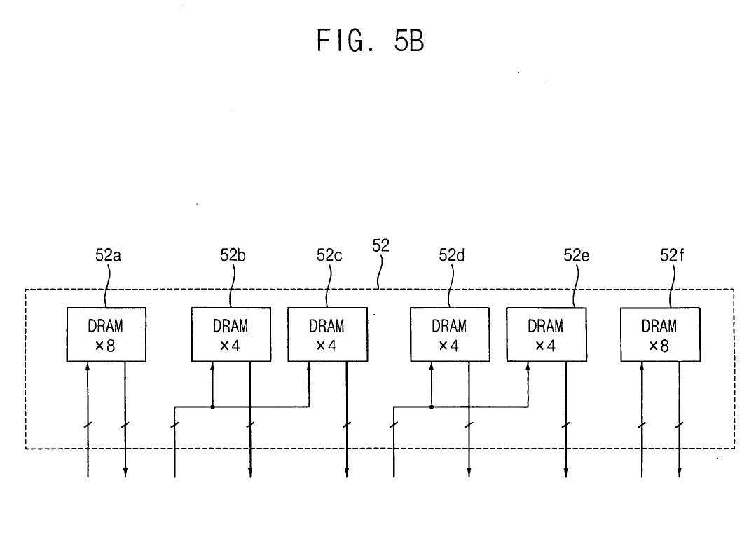

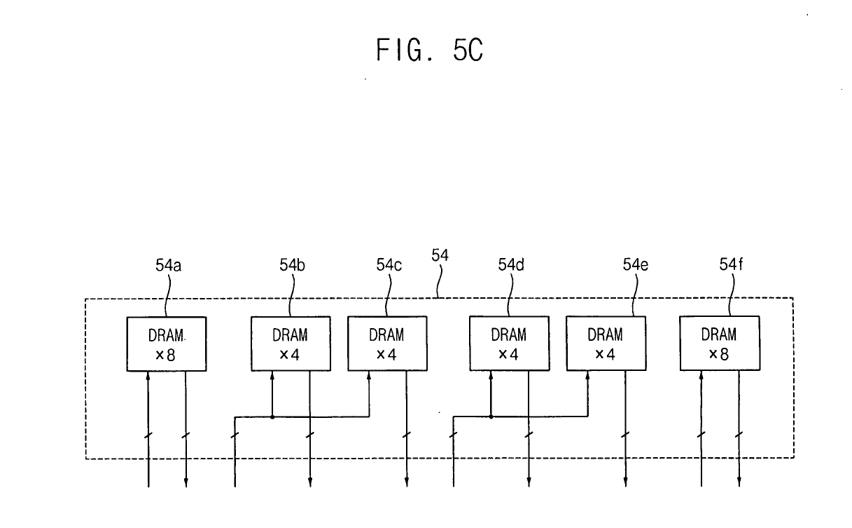

FIG. 5A through FIG. 5C are block diagrams illustrating various configurations of a memory module according to example embodiments of the present invention.

Referring to FIG. 5A, a memory module 50 includes a plurality of DRAM components that have equal memory sizes and equal numbers of data I/O pins. When each DRAM component is configured with a 128 Mbits×8 DRAM component that has eight data I/O pins, a memory size of the memory module 50 corresponds to 512 Mbytes because a memory size of the respective DRAM component corresponds to 128 Mbytes. Four DRAM components 50a, 50b, 50c and 50d are respectively coupled to a memory controller through channels. That is, the channels independently transfer commands and addresses.

Referring to FIG. 5B, a memory module 52 includes a plurality of DRAM components that have equal memory sizes but different numbers of the data I/O pins. The DRAM components 52a and 52f are respectively configured with a 128 Mbits×8 DRAM component that has eight data I/O pins, and the DRAM components 52b, 52c, 52d and 52e are respectively configured with a 256 Mbits×4 DRAM component that has four data I/O pins. Therefore, a memory size of the memory module 52 corresponds to 768 Mbytes (i.e., 128 Mbyte×6).

A pair of the DRAM components 52b and 52c shares a downloading bus to share a command/address bus. However, each of DRAM components 52b and 52c has a respective uploading bus. Similarly, a pair of the DRAM components 52d and 52e shares a downloading bus to share a command/address bus. However, each of DRAM components 52d and 52e has a respective uploading bus. Thus, the number of I/O pins in the memory module 52 in FIG. 5B corresponds to thirty two that is the same as that of the memory module 50 in FIG. 5A. However, the memory size of the memory module 52 corresponds to 768 MBytes whereas the memory size of the memory module 50 corresponds to 512 MBytes.

The DRAM component 52a, the pairs of the DRAM components (52b and 52c) and (52d and 52e), and the DRAM components 52f are independently coupled to the memory controller.

As described above, in the memory module 52, DRAM components that have different numbers of I/O pins are combined to change the memory size of the memory module.

Referring to FIG. 5C, a memory module 54 includes a plurality of DRAM components that have different memory depths and different numbers of I/O pins. The DRAM components 54a and 54f are respectively configured with a 64 Mbits×8 DRAM component that has eight data I/O pins, and the DRAM components 54b, 54c, 54d, and 54e are respectively configured with a 256 Mbits×4 DRAM component that has four data I/O pins. Therefore, a memory size of the memory module 54 corresponds to 640 Mbytes (i.e., 64 Mbytes×2+128 Mbytes×4).

A pair of the DRAM components 54b and 54c shares a downloading bus, but each of DRAM components 54b and 54c has a respective uploading bus. Similarly, a pair of the DRAM components 54d and 54e shares a downloading bus, but each of DRAM components 54d and 54c has a respective uploading bus. Thus, the number of I/O pins in the memory module 54 in FIG. 5C corresponds to thirty two that is the same as that of the memory module 50 in FIG. 5A. However, the memory size of the memory module 54 corresponds to 640 MBytes whereas the memory size of the memory module 50 corresponds to 512 MBytes. The DRAM component 54a, the pairs of the DRAM components (54b and 54c) and (54d and 54e) and the DRAM component 54f are independently coupled to the memory controller.

As described above, the memory size of the memory module may be optimized by configuring the DRAM components that have different sizes.

Additionally, the memory sizes of the memory modules 52 and 54 may not follow a two-square law. For example, the memory sizes of the memory modules 52 and 54 may respectively correspond to 768 Mbytes and 640 Mbytes as described above. The number of DRAM components in the memory module may correspond to a value of ‘6’ instead of a value of ‘4’ and a value of ‘8,’ and as a result, the memory size of the memory module that has an adequate size according to an application field may be designed.

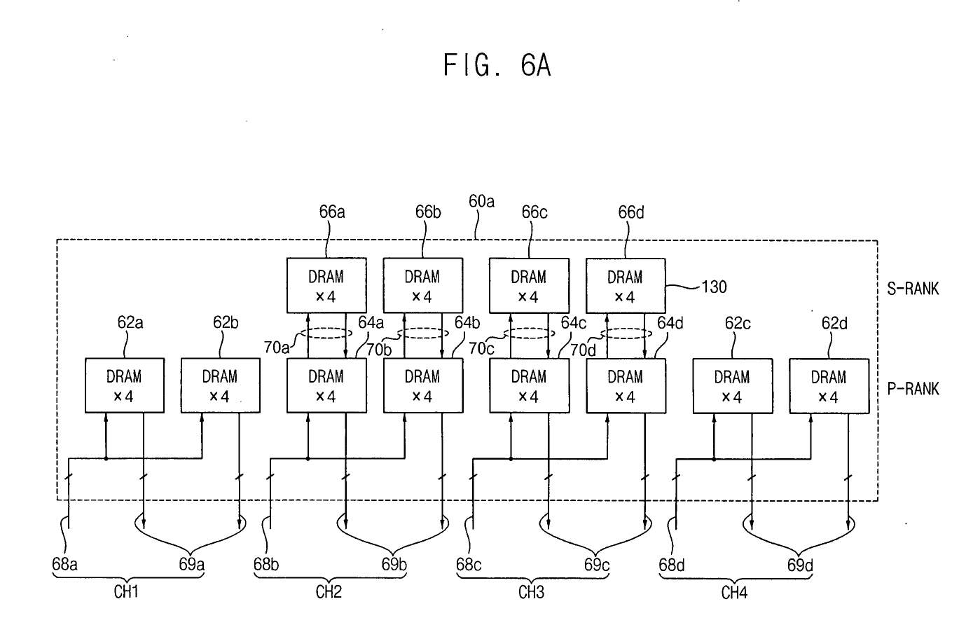

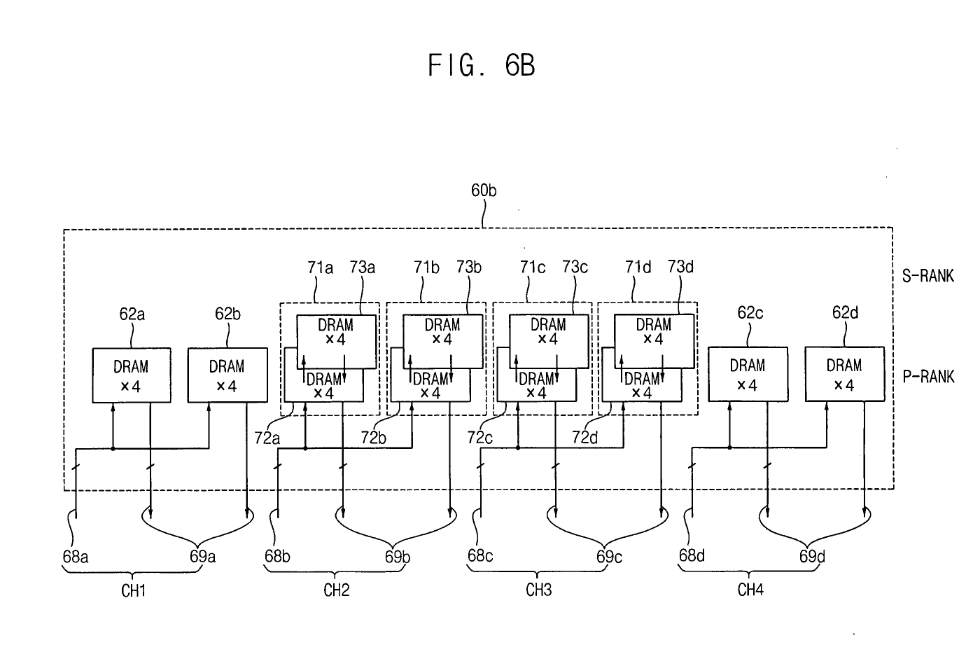

FIGS. 6A and 6B are block diagrams illustrating memory modules having a hierarchical relay link architecture according to example embodiments of the present invention.

FIG. 6A illustrates an example of a memory module including a single memory component, and FIG. 6B illustrates an example of a memory module including a multi-chip module.

As illustrated in FIG. 6A, a memory module 60a may optimally use a free space that is large enough for eight DRAM components but too small for sixteen DRAM components.

Referring to FIG. 6A, the memory module 60a includes eight DRAM components 62a, 62b, 62c, 62d, 64a, 64b, 64c and 64d arranged in a primary rank, and four DRAM components 66a, 66b, 66c and 66d arranged in a secondary rank.

The two DRAM components 62a and 62b arranged in the primary rank share a downloading bus 68a and have separate uploading buses 69a. The two DRAM components 62c and 62d arranged in the primary rank share a downloading bus 68d and have separate uploading buses 69d. The two DRAM components 64a and 64b arranged in the primary rank share a download bus 68b and have separate uploading buses 69b. The two DRAM components 64c and 64d arranged in the primary rank share a downloading bus 68c and have separate uploading buses 69c. Additionally, the four DRAM components 64a, 64b, 64c and 64d are respectively coupled to the four DRAM components 66a, 66b, 66c and 66d through relay buses 70a, 70b, 70c and 70d.

Command/address packets and write data packets are transmitted through the downloading buses 68a, 68b, 68c and 68d, and read data packets are transmitted through the uploading buses 69a, 69b, 69c and 69d. Pairs of the DRAM components (62a and 62b), (64a and 64b), (64c and 64d) and (62c and 62d) respectively share downloading buses 68a, 68b, 68c and 68d such that the pairs of the DRAM components (62a and 62b), (64a and 64b), (64c and 64d) and (62c and 62d) respectively have a common command/address.

Therefore, the memory module 60 includes four channels CH1, CH2, CH3 and CH4. The channels CH1 and CH4 are respectively configured with a single layer and the channels CH2 and CH3 are respectively configured with a relay link architecture.

As illustrated in FIG. 6B, a memory module 60b may optimally use a free space that is sufficient for eight DRAM components but insufficient for sixteen DRAM components with a limitation of area in a single plane.

In comparison with the memory module 60a in FIG. 6A, the memory module 60b in FIG. 6B replaces the DRAM components 64a, 64b, 64c and 64d that have the hierarchical link architecture in the channels CH2 and CH3 with multi-chip modules 71a, 71b, 71c and 71d. The lower DRAM components 72a, 72b, 72c and 72d of the multi-chip modules 71a, 71b, 71c and 71d are in the primary rank and the upper DRAM components 73a, 73b, 73c and 73d of the memory modules 71a, 71b, 71c and 71d are in the secondary rank.

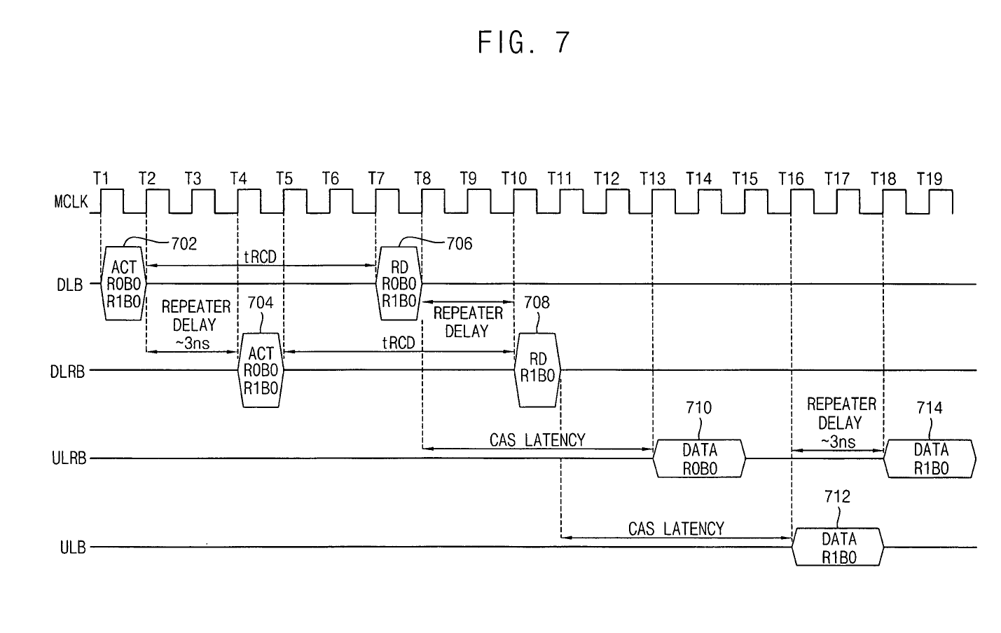

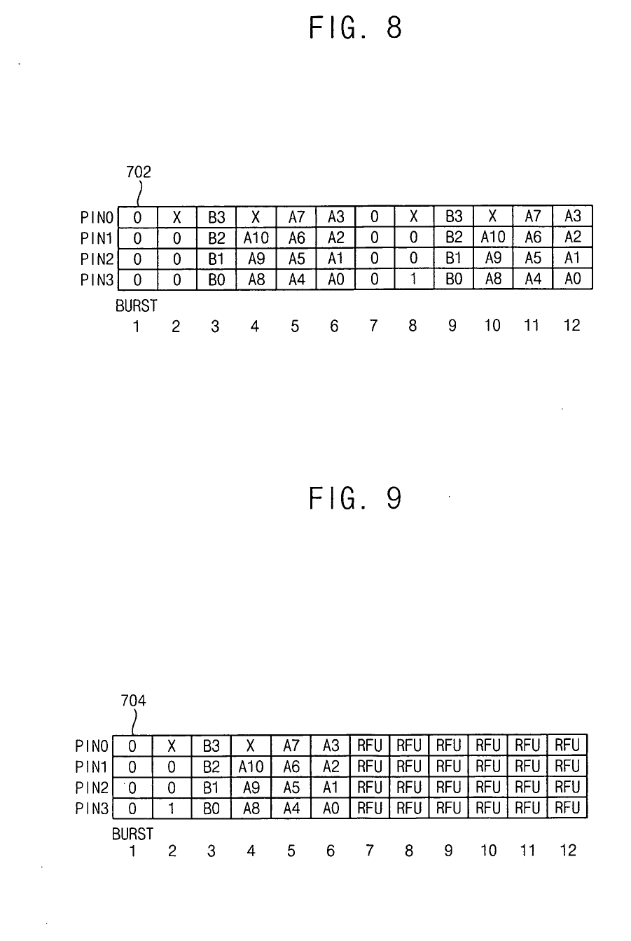

FIG. 7 is a timing diagram illustrating a read operation of the memory module in FIG. 6A. FIGS. 8 through 11 are tables illustrating a configuration of a command/address packet.

Referring to FIGS. 7 through 11, a memory controller sets an operation speed of the DRAM components 64a, 64b, 64c and 64d arranged in the primary rank and the DRAM components 66a, 66b, 66c and 66d arranged in the secondary rank as a predetermined operation speed by a mode register set (MRS) command. The memory controller may set a column latency to six clocks as shown in FIG. 7. The memory controller transmits the command/address packet to the memory module 60a through the downloading buses 68b and 68c.

The DRAM component 64a receives a first command/address packet 702 in FIG. 8 through the downloading bus 68b at a rising edge T1 of a clock signal MCLK.

In the first command/address packet 702, field values of CS0, CS1 and CS2 corresponding to pins PIN1, PIN2 and PIN3 in a BURST2 column are ‘000.’ Thus, the DRAM component 64a, 64b, 64c and 64d perform an ACT command when field values of OP0, OP1, OP2 and OP3 corresponding to the pins PIN0, PIN1, PIN2 and PIN3 in a BURST1 column are ‘0000’. Herein, the field values of OP0, OP1, OP2 and OP3 are configured with four bits, thereby representing sixteen commands.

The DRAM component 64a activates a corresponding bank and a corresponding memory cell corresponding to the received row address. The DRAM component 64a reads cell data of the memory cell and transfers the read cell data to a sense amplifier.

Concurrently, the DRAM component 64a relays a second command/address packet 704 in FIG. 9 through the relay bus 70a at a rising edge T4 of the clock signal MCLK. The second command/address packet 704 includes packet data that is included in a column of BURST7 through BURST12 in the first command/address packet 702.

The DRAM memory component 66a interprets the relayed packet, that is, the second command/address packet 704.

In the second command/address packet 704, field values of RS0, RS1 and RS2 corresponding to the pins PIN1, PIN2 and PIN3 in a BURST2 column are ‘001.’ Thus, the DRAM component 66a perform the ACT command of ‘0000’ in a BURST1 column that is field values of OP0, OP1, OP2 and OP3 corresponding to the pins PIN0, PIN1, PIN2 and PIN3.

The DRAM component 66a activates a corresponding bank and a corresponding memory cell corresponding to the received row address. The DRAM component 64a reads cell data of the memory cell and transfers the read cell data to a sense amplifier.

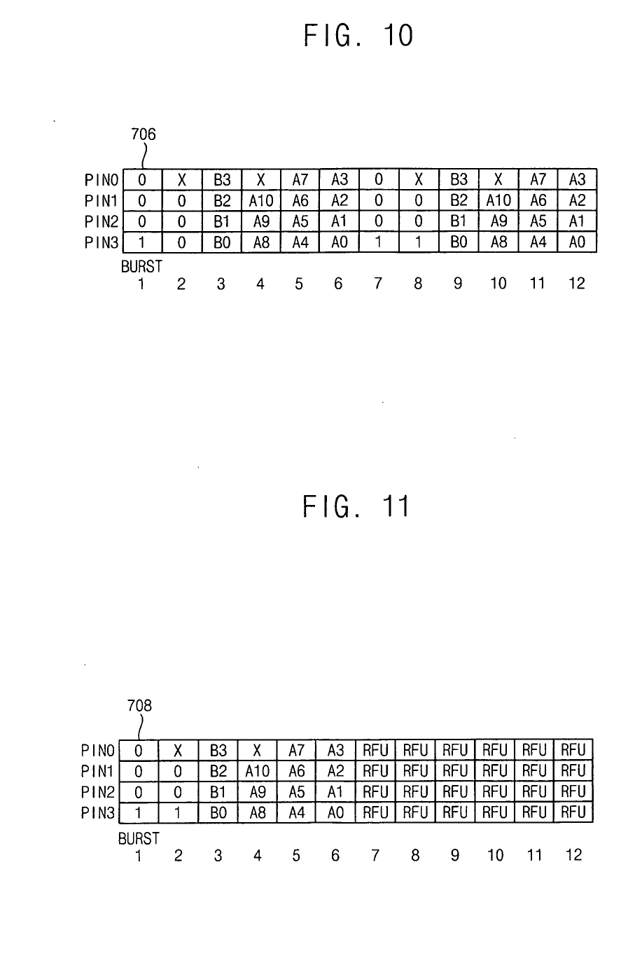

The DRAM component 64a receives a third command/address packet 706 in FIG. 10 through the downloading bus 68b at a rising edge T7 of the clock signal MCLK.

In the third command/address packet 706, field values of CS0, CS1 and CS2 corresponding to of the pins PIN1, PIN2, and PIN3 in a BURST2 column are ‘000.’ Thus, the DRAM component 64a perform a READ command when field values of OP0, OP1, OP2 and OP3 corresponding to the pins PIN0, PIN1, PIN2 and PIN3 in a BURST1 column are ‘0001.’

The DRAM component 64a transmits cell data corresponding to a read address among a plurality of cell data amplified by the sense amplifier through an output buffer. The output buffer transmits a read data packet 710 after a CAS latency of six clocks set by the MRS.

The cell data read from the DRAM component 64a is transmitted to the memory controller through the uploading bus 69a at a rising edge T13 of the clock signal MCLK.

The DRAM component 66a receives a fourth command/address packet 708 through the relay bus 70a at a rising edge T10 of the clock signal MCLK.

In the fourth command/address packet 708, field values of RS0, RS1 and RS2 corresponding to of the pins PIN1, PIN2 and PIN3 in a BURST2 column are ‘001.’ Thus, the DRAM component 64a performs a READ command when field values of OP0, OP1, OP2 and OP3 corresponding to of the pins PIN0, PIN1, PIN2 and PIN3 in a BURST1 column are ‘0001.’

The DRAM component 66a transmits a cell data corresponding to a read address among a plurality of cell data amplified by the sense amplifier through an output buffer. The output buffer transmits a read data packet 712 after the CAS latency of six clocks set by the MRS.

The cell data read from the DRAM component 66a is transmitted to the DRAM component 64a through the uploading bus 69a.

The DRAM component 64a relays the transmitted read data packet 712 to the memory controller through the uploading bus 69a. That is, the DRAM component 64a transmits the relayed data packet 712 after a relay delay time, which corresponds to a value of about ‘3 ns’ at a rising edge T18 of the clock signal MCLK.

As described above, the memory system according to example embodiments of the present invention may optimize a memory size of the memory module and may optimally use a free space by configuring the memory components that have a different size and by combining relay link architecture.

While the example embodiments of the present invention and their advantages have been described in detail, it should be understood that various changes, substitutions and alterations may be made herein without departing from the scope of the invention.

What is claimed is:

1. A memory system, comprising:
a memory controller having a plurality of input/output (I/O) channels, each of the I/O channels including a command/address bus and a data bus; and
a plurality of first memory components respectively coupled to the memory controller through the plurality of I/O channels,
wherein the memory controller transmits commands/addresses and data to the plurality of first memory components through the plurality of I/O channels in order to independently control the plurality of first memory components.

2. The memory system of claim 1, further comprising:
a plurality of second memory components dependently coupled to at least one of the first memory components,
wherein the at least one of the first memory components respectively relay the commands/addresses and the data between the memory controller and the plurality of second memory components.

3. The memory system of claim 2, wherein the plurality of first and second memory components are mounted on a module board having an area for memory components of a number not greater than 2^{N+1}, the number of the first memory components arranged in a primary rank being 2^{N}, the number of the second memory components arranged in a secondary rank being not greater than 2^{N}.

4. The memory system of claim 2, wherein the plurality of first and second memory components are mounted on a module board having an area for memory components of a number of about 2^{N}, the number of the first memory components arranged in a primary rank being 2^{N}, the number of the second memory components arranged in a secondary rank being not greater than 2^{N}, the first memory components being disposed on or over the second memory components.

5. The memory system of claim 2, wherein at least one of a memory size, a number of banks, a depth of the bank, a page size and a burst length of the first memory components is different from that of the second memory components.

6. A method of controlling a memory system in which first and second memory components are respectively coupled to a memory controller through first and second channels, comprising:
writing first and second memory scheduling information respectively corresponding to the first and second memory components;
controlling the first memory components according to the first memory scheduling information; and
controlling the second memory components according to the second memory scheduling information.

7. The method of claim 6, wherein controlling the first memory components and controlling the second memory components respectively include transmitting a command/address and data through the first and second channels.

8. The method of claim 7, wherein controlling the first memory components and controlling the second memory components include rearranging the command/address and the data such that a total power consumed by the first memory components and the second memory components is reduced.

9. A memory controller, comprising:
a micro-code memory configured to store a program code for controlling the memory controller,
wherein controlling the memory controller comprises:
writing first and second memory scheduling information respectively corresponding to first and second memory components;
controlling the first memory components according to the first memory scheduling information; and
controlling the second memory components according to the second memory scheduling information.

10. The method of claim 9, wherein controlling the first memory components and controlling the second memory components include rearranging a command/address and data such that a total power consumed by the first memory components and the second memory components is reduced.

11. A memory module, comprising:
a module board having a plurality of I/O channels for coupling the module board to a memory controller; and
a plurality of first memory components respectively coupled to the memory controller through the I/O channels and mounted on the module board, the first memory components respectively receiving commands/addresses and data through the I/O channels from the memory controller and being independently operated.

12. The memory module of claim 11, further comprising:
a plurality of second memory components dependently coupled to at least one of the first memory components,
wherein the at least one of the first memory components respectively relay the commands/addresses and the data between the memory controller and the plurality of second memory components.
